(19) United States
(12) Patent Application Publication
(10) Pub. No.: US 2011/0263422 A1
(43) Pub. Date: Oct. 27, 2011

(54) Aqueous dispersion comprising pesticide particles and an amphiphile

(75) Inventor: Sebastian Koltzenburg, Dannstadt-Schauernheim (DE)

(73) Assignee: BASF SE, Ludwigshafen (DE)

(21) Appl. No.: 13/140,114

(22) PCT Filed: Dec. 10, 2009
(86) PCT No.: PCT/EP2009/066837

§ 371 Date: Jun. 16, 2011

(30) Foreign Application Priority Data
Dec. 18, 2008 (EP) 08172206.8

(51) Int. Cl. A01C 1/06; A01N 25/00; A01P 3/00; A01P 13/00; A01P 21/00; A01P 7/02; A01N 25/04; A01P 7/04

(52) U.S. Cl. 504/100; 424/405; 504/358; 504/362

(57) ABSTRACT

The present invention relates to an aqueous dispersion comprising solid active substance particles with a particle size of up to 10 μm and an amphiphile. The invention furthermore relates to a method of preparing the dispersion by bringing an active substance and an amphiphile into contact. The invention furthermore relates to a solid composition comprising active substance particles with a particle size of up to 10 μm and an amphiphile, obtained by drying the aqueous dispersion. Moreover, the invention relates to the use of the dispersion or the solid composition for controlling phytopathogenic fungi and/or undesired vegetation and/or undesired attack by insects or mites and/or for regulating the growth of plants. Finally, the invention relates to seed, treated with the dispersion or the solid composition.

The present invention relates to an aqueous dispersion comprising solid active substance particles with a particle size of up to 10 μm and an amphiphile. The invention furthermore relates to a method of preparing of the dispersion by bringing an active substance and an amphiphile into contact. The invention furthermore relates to a solid composition comprising active substance particles with a particle size of up to 10 μm and an amphiphile, obtained by drying the aqueous dispersion. Moreover, the invention relates to the use of the dispersion or of the solid composition for controlling phytopathogenic fungi and/or undesired vegetation and/or undesired attack by insects or mites and/or for regulating the growth of plants, by allowing the dispersion or the solid composition to act on the respective pests, their environment and/or the plants to be protected from the respective pest, on the soil and/or on undesired plants and/or on the useful plants and/or their environment, and to the use of the dispersion or of the solid composition for controlling undesired attack by insects or mites on plants and/or for controlling phytopathogenic fungi and/or for controlling undesired vegetation by treating seed of useful plants with the dispersion or the solid composition. Finally, the invention relates to seed, treated with the dispersion or the solid composition. Combinations of preferred features with other preferred features are comprised by the present invention.

Many active substances, for example pesticides, are ideally provided in the form of aqueous systems. Naturally, this makes efficient application of active substances which are insoluble in water more difficult, since the concentration available in the aqueous solution, and hence the biological activity are low. It is known that the solubility, dispersibility and bioavailability of active substance particles can be increased by enlarging the particle surface area, that is to say by making the particle size smaller while retaining the same total amount. For example, the penetration of biological membranes is made easier when particle size is smaller. Likewise, dissolution rate and apparent solubility of the particles are increased; see also Müller R H, Benita S, Böhm B H L, eds. Stuttgart, Germany: Medpharm Scientific Publishers; 1998. This means at the same time that the active substance quantities required when using particles on the magnitude of a few micrometers, preferably less than one micrometer, are smaller for achieving the same effect than when the active substance is used in the form of larger particles.

Surface-active substances which inhibit the agglomeration of the particles are frequently employed for the colloidal stabilization of systems with particle sizes of below ten micrometers. Typical stabilizers are low-molecular-weight surfactants or oligomers. Higher-molecular-weight adjuvants, such as, for example, colloids and amphiphilic polymers, however, also offer the possibility of stabilizing active substance particles in small dimensions. Likewise, it is possible to osmotically stabilize ultra finely divided dispersions against Ostwald ripening by adding substances which are extremely sparingly soluble in water, such as, for example, hexadecane.

Aqueous dispersions comprising active substance particles with a particle size of less than 10 μm and an amphiphile are generally known:

WO 1995/25504 discloses a pharmaceutical composition comprising a stable emulsion of a drug enclosed in a hydrophobic emulsion of a long-chain carboxylic acid, which may be erucic acid, for example.

WO 2008/002485 discloses nanoparticles comprising an amorphous drug core and a stabilizer absorbed on the surface of the core. The stabilizers mentioned are stearic acid or sodium dodecylsulfate.

WO 2004/006959 discloses nanoparticle-comprising liquid compositions comprising particles with a size of below 2000 nm, stabilizer and osmotically active crystallization inhibitor. The stabilizer is, for example, stearic acid or phosphates.

WO 2008/100896 discloses a composition comprising acid, emulsifier, coemulsifier and water. The composition may additionally comprise erucic acid.

WO 1998/04761 discloses a microemulsion comprising no less than 40% by weight of water, organic solvent and an anionic surfactant which is selected from among aliphatic carboxylic acids having 14 to 23 carbon atoms.

WO 2003/059063 discloses a fungicide composition comprising a fatty acid having 5 to 22 carbon atoms and a selected organic acid. The fatty acid may be erucic acid, for example.

EP 0 388 239 discloses an aqueous suspension comprising a surfactant and particles of a sparingly soluble agrochemical active substance.

The disadvantage of the prior art is, inter alia, that an insufficient stabilization of the particles to particle growth is obtained, so that additional crystallization inhibitors, coemulsifiers or further organic acids must be added.

It was an object of the present invention to identify novel ways of stably formulating pesticide particles with a particle size of below 10 μm. In particular, it was intended that the method should manage with inexpensive, industrially available substances which are also very environmentally friendly.

The object was achieved by an aqueous dispersion comprising active substance particles with a particle size of up to 10 μm and an amphiphile, wherein the amphiphile is soluble in water at 20° C. to no more than 10% by weight.

In general, an amphiphile is understood as meaning a substance or a mixture of substances of at least one hydrophilic and at least one hydrophobic unit. Hydrophobic units are usually extremely sparingly soluble in water. This is understood as meaning a solubility in water of <1 g/l, preferably <0.1 g/l, especially preferably <0.01 g/l and in particular <0.001 g/l. Examples are long-chain alkanes, fused aromatic ring systems, silicones and perfluorinated compounds. The hydrophilic unit is polar and interacts energetically favorably with water. It may take the form of acid groups such as, for example, carboxylic acid, sulfonic acid, phosphoric acid, phosphonic acid, or neutralized embodiments of these groups, for example with alkali metal or ammonium ions as counterion, such as, for example, sodium, lithium, potassium, ammonium or tetraalkylammonium, such as, for example, tetrabutylammonium. Likewise, the hydrophilic unit may be an oligoether such as, for example, oligo(ethylene oxide). The units are either linked directly or by other chemical linkers which are known to the skilled worker, such as, for example, an ester or amide bond. In one embodiment, amphiphiles have a Krafft point of at least 25° C., preferably at least 40° C. and especially preferably at least 60° C. At temperatures below the Krafft point, no micelles are present, and the material appears to be insoluble in water. The molecular residual solubility is low and is below 1 g/l, preferably <0.1 g/l, especially preferably <0.01 g/l and in particular <0.001 g/l. In a preferred embodiment, the amphiphile is soluble in water at 20° C. to no more than 10% by weight, preferably to no more than 1% by weight, especially preferably to no more than 0.1% by weight, specifically to no more than 0.01% by weight.

Preferably, the amphiphile is an aliphatic acid or a salt thereof, the aliphatic acid being soluble in water at 20° C. to no more than 10% by weight. The aliphatic acid is soluble in water at 20° C. to no more than 10% by weight, preferably no more than 1% by weight, especially preferably no more than 0.1% by weight, specifically no more than 0.01% by weight. If the amphiphile is the salt of an aliphatic acid, the aliphatic acid is usually employed for determining the solubility in water. The aliphatic acid usually comprises a linear or branched, saturated or unsaturated aliphatic group, and an acid group such as a carboxyl group, sulfonyl group or phosphoric acid group, preferably a carboxyl group. Suitable salts of the aliphatic acid are, for example, alkali metal, alkaline earth metal or ammonium salts of the aliphatic acid. Mixtures of the abovementioned aliphatic acids, their salts or of aliphatic acid with salts of aliphatic acids are also possible.

The aliphatic acid is preferably a fatty acid having at least 20 carbon atoms. Preferably, the fatty acid comprises 22 to 36 carbon atoms. It may be linear or branched, saturated or unsaturated. Suitable fatty acids are, for example, arachidonic acid (C20), behenic acid (C22), erucic acid (C22), lignoceric acid (C24), cerotic acid (C26) or melissic acid (C30), preferably erucic acid and behenic acid, in particular erucic acid. Erucic acid (cis-13-docosaenoic acid) is a monounsaturated fatty acid which is found in large quantities in the seed of some oilseed rape varieties and seakale varieties, especially in Abyssinian kale (Crambe abyssinica).

In most cases, the dispersion according to the invention comprises no more than 40% by weight, preferably no more than 35% by weight, especially preferably no more than 30% by weight, of the amphiphile based on the active substance employed. Usually, the dispersion comprises at least 1% by weight, preferably at least 3% by weight, especially preferably at least 5% by weight and specifically at least 15% by weight of the amphiphile, based on the active substance employed.

An aqueous dispersion may be an aqueous emulsion or aqueous suspension, it is preferably an aqueous suspension. In this context, the term “suspension” is also understood as meaning in particular dispersions of particles from supercooled melts, which comprise particles below their equilibrium melting point.

An aqueous dispersion usually comprises water as the continuous phase, and solid particles as the disperse phase. In most cases, the dispersion according to the invention comprises from 30 to 98% by weight, preferably from 40 to 90% by weight, especially preferably from 50 to 80% by weight, of water.

In most cases, the active substance particles comprise at least 80% by weight, preferably at least 90% by weight, especially preferably at least 95% by weight, of active substance. The active substance particles preferably consist of active substance. The content of active substance particles with a particle size of below 10 μm in the aqueous suspension may vary within wide ranges, such as from 0.001 to 50% by weight, preferably from 0.01 to 40% by weight.

The particle size of the active substance particles usually refers to the number-average particle size. It is below 10 μm, preferably below 2 μm, especially preferably below 1 μm. In most cases, the particle size is above 5 nm, preferably above 20 nm, especially preferably above 50 nm. In most cases, the particle size is determined by means of photon correlation spectroscopy (dynamic light scattering), for example using an apparatus of the Brookhaven Instruments BI90 brand. In this measuring method, the sample preparation, for example the dilution to the measuring concentration, depends, inter alia, on the fineness and concentration of the active substances in the dispersion sample and on the instrument used. The procedure must be established for the system in question and is known to the skilled worker.

The solid active substance particles may be crystalline or amorphous, preferably amorphous. Amorphous means that the molecular units of a homogeneous solid are not arranged in the form of crystal lattices. Amorphous active substance particles means that the particles are largely free from crystalline active substance, with preferably from 80 to 100% by weight, in particular from 90 to 100% by weight, of the material being in amorphous form. Amorphous forms can be distinguished from crystalline forms by a variety of methods, for example by examination under a microscope in polarized light, differential scanning calorimetry (DSC), x-ray diffraction or solubility comparisons, preferably by means of DSC.

Suitable active substances are, for example, colors, cosmetic active substances, pharmacological active substances, pesticides, fertilizers, additives for foodstuffs or feeding stuffs, adjuvants for polymers, paper, textile, leather or detergents and cleaning products. Mixtures of the above active substances are also suitable. In general, active substances which are well suited are those which are soluble in water at 20° C. to no more than 10 g/l, preferably no more than 1 g/l, especially preferably no more than 0.1 g/l and specifically no more than 0.01 g/l.

In most cases, the dispersion according to the invention comprises from 1 to 60% by weight, preferably from 5 to 50% by weight, of active substance particles, based on the dispersion. Usually, it comprises no more than 40% by weight, preferably no more than 30% by weight, of amphiphile based on the active substance. Usually it comprises at least 0.1% by weight, preferably at least 1% by weight, especially preferably at least 5% by weight, of amphiphile based on the active substance.

Examples of colors are colorants, printing inks, pigments, UV absorbers, optical brighteners or IR colorants. While organic colorants have an absorption maximum in the wavelength range of from 400 to 850 nm, optical brighteners have one or more absorption maxima in the range of from 250 to 400 nm. As is known, optical brighteners emit a fluorescence radiation in the visible range when irradiated with UV light. Examples of optical brighteners are compounds from the classes of the bisstyrylbenzenes, stilbenes, benzoxazoles, coumarins, pyrenes and naphthalenes. Others which are suitable are markers for fluids, for example mineral oil markers. UV absorbers are generally understood as compounds which absorb UV rays and which deactivate the absorbed radiation in a nonradiative fashion. Such compounds are employed for example in sunscreens and for stabilizing organic polymers.

Further suitable active substances are cosmetic active substances. Cosmetics are substances or preparations of substances which exclusively or predominantly are intended to be used externally on the human body or in the oral cavity for the purposes of cleansing, caring, protecting, maintaining good health, perfuming, for modifying the appearance or for influencing body odor. Others which are suitable are, for example, insect repellants such as icaridin or N,N-diethyl-meta-toluamide (DEET).

Furthermore, all pharmaceutical active substances may be employed as active substances.

Further suitable active substances are additives for foodstuffs or feeding stuffs, such as food colorants, amino acids, vitamins, preservatives, antioxidants, aroma substances or fragrances.

Pesticides and fertilizers may also be used as active substances, preferably pesticides.

Especially preferred active substances are pesticides. The term pesticide refers to at least one active substance selected from the group of the fungicides, insecticides, nematicides, herbicides, safeners and/or growth regulators. Preferred pesticides are fungicides, insecticides and herbicides. Mixtures of pesticides from two or more of the abovementioned classes may also be used. The skilled worker is familiar with those pesticides, which can be found for example in Pesticide Manual, 14th Ed. (2006), The British Crop Protection Council, London.

Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds, nereistoxin analogs, benzoylureas, diacylhydrazines, METI acaricides, and insecticides such as chloropicrin, pymetrozin, flonicamid, clofentezin, hexythiazox, etoxazole, diafenthiuron, propargite, tetradifon, chlorfenapyr, DNOC, buprofezin, cyromazin, amitraz, hydramethylnon, acequinocyl, fluacrypyrim, rotenone, or their derivatives.

Suitable fungicides are fungicides from the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzylcarbamates, carbamates, carboxamides, carboxylic acid amides, chloronitriles, cyanoacetamideoximes, cyanoimidazoles, cyclopropanecarboxamides, dicarboximides, dihydrodioxazines, dinitrophenylcrotonates, dithiocarbamates, dithiolanes, ethylphosphonates, ethylaminothiazolecarboxamides, guanidines, hydroxy-(2-amino-)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiocarbamates, thiophanates, thiophenecarboxamides, toluamides, triphenyltin compounds, triazines, triazoles.

Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidiniumdiones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

Preferred pesticides are those which are insoluble in water. Suitable insoluble pesticides are those which are soluble at 20° C. in water to no more than 3% by weight, preferably no more than 1% by weight, preferably no more than 0.1% by weight and very especially preferably no more than 0.01%. Examples of suitable insoluble pesticides are (solubility in water at 20° C. in each case in parentheses) pyraclostrobin (1.9 mg/l), epoxiconazole (6.6 mg/l), prochloraz (34 mg/l), preferably pyraclostrobin.

The pesticides employed are frequently solids at 20° C. The melting point is preferably at least 30° C. and preferably at least 40° C.

The invention also relates to a method of preparing the dispersion according to the invention by bringing an active substance and an amphiphile into contact, the amphiphile being soluble in water at 20° C. to no more than 10% by weight. It is possible to bring the dispersed active substance into contact with the amphiphile, or to disperse after active substance and amphiphile have been brought into contact. The skilled worker is generally familiar with a wide range of methods for dispersing active substances such as pesticides. Examples of suitable processes are precipitation methods, emulsification methods, evaporation methods, melt emulsification or milling methods, preferably precipitation methods. It is preferred to bring the active substance and the amphiphile into contact in an aqueous system and to disperse the mixture. It is especially preferred to employ the amphiphile in an organic solvent, specifically in the same solvent system as the active substance. Suitable active substances are those described above. The active substance is usually insoluble in water. The active substance is preferably a pesticide which is insoluble in water. Suitable amphiphiles are the above-described amphiphiles. The amphiphile is preferably a fatty acid which comprises at least 20, preferably 22 to 36, carbon atoms.

Especially preferred methods are carried out in such a way that

an aqueous solution is prepared, the active substance and the amphiphile are dissolved in a water-miscible organic solvent, and the two solutions are mixed turbulently (precipitation method);
the active substance and the amphiphile are dissolved in an organic solvent which is not miscible with water, the solution is mixed turbulently with an aqueous solution, and the organic solvent is optionally removed (emulsifying method, optionally combined with evaporation);
a melt comprising molten active substance and the amphiphile is mixed with an aqueous solution and cooled (melt emulsification); or
the active substance is milled in the presence of the amphiphile (milling method).

Specifically suitable is a method in which an aqueous solution is provided, the active substance and the amphiphile are dissolved in a water-miscible organic solvent, and the two solutions are mixed turbently (precipitation method).

In most cases, the solution of the active substance and of the amphiphile in a water-miscible organic solvent comprises a water-miscible organic solvent. Water-miscible means in this context that the organic solvents are miscible with water at 20° C. without phase separation to at least 10% by weight, preferably to 15% by weight, especially preferably to 20% by weight. Optionally, the solution may comprise further formulation adjuvants, for example dispersants. If required, the solution may be prepared at elevated temperature. Suitable solvents are C₁-C₆-alkyl alcohols such as methanol, ethanol, propanol, isopropanol, 1-butanol, 2-butanol, tert-butanol, esters, ketones such as acetone, methyl ethyl ketone, methyl isopropyl ketone, methyl isobutyl ketone, acetals, ethers, cyclic ethers such as tetrahydrofuran, aliphatic carboxylic acids such as formic acid, acetic acid, propionic acid, N-substituted or N,N-disubstituted carbonamides such as acetamide, carboxylic esters such as, for example, ethyl acetate, and lactones such as, for example, butyrolactone, dimethylformamide (DMF) and dimethylpropionamide, aliphatic and aromatic hydrochlorocarbons such as methylene chloride, chloroform, 1,2-dichloroethane or chlorobenzene, N-lactams, glycols such as ethylene glycol or propylene glycol, and mixtures of above-mentioned solvents. Preferred solvents are glycols, methanol, ethanol, isopropanol, dimethylformamide, N-methylpyrrolidone, methylene chloride, chloroform, 1,2-dichloroethane, chlorobenzene, acetone, methyl ethyl ketone, methyl isopropyl ketone, methyl isobutyl ketone, tetrahydrofuran, and mixtures of abovementioned solvents.

Especially preferred solvents are propylene glycol, methanol, ethanol, isopropanol, dimethylformamide and tetrahydrofuran, in particular propylene glycol.

The aqueous solution comprises water and optionally further formulation adjuvants, for example dispersants.

For carrying out the turbulent mixing, generally known methods are known to the skilled worker. The process step can be carried out batchwise, for example in a stirred vessel, or continuously. Continuously operating machines and apparatuses for emulsification are, for example, colloid mills, toothed-ring dispersers and other structural shapes of dynamic mixers, furthermore high-pressure homogenizers, pumps with downstream nozzles, valves, membranes or other narrow slit geometries, static mixers, inline mixers operating on the rotor/stator principle (Ultra-Turrax, Inline Dissolver), micro-mixing systems and ultrasonic emulsifier systems. It is preferred to employ toothed-ring dispersers or high-pressure homogenizers. The temperature of the solutions employed can be from 20 to 200° C., preferably 50 to 150° C. In a further preferred embodiment, the turbulent mixing may take place in a mixing chamber.

The dispersion prepared by the method according to the invention can be diluted or used further as such. It is furthermore possible to concentrate the aqueous dispersion.

Usually, an active substance as described above is employed in the method according to the invention. It is preferred to employ a pesticide which is insoluble in water. The amphiphiles are, employed in the method in most cases, the above-described aliphatic acids, in particular a fatty acid which comprises at least 20, preferably 22 to 36, carbon atoms.

Further formulation adjuvants may optionally be added before, during or after the method. Formulation adjuvants are, for example, solvents, surfactants, inorganic emulsifiers (known as Pickering emulsifiers), antifoams, thickeners, antifreeze agents, and bactericides. Formulations intended for seed treatment may additionally also comprise adhesives and optionally pigments.

Suitable solvents are water, organic solvents such as mineral oil fractions of medium to high boiling point such as kerosine and diesel oil, furthermore, coal tar oils and oils of vegetable or animal origin, aliphatic, cyclic and aromatic hydrocarbons, for example paraffins, tetrahydronaphthalene, alkylated naphthalenes and their derivatives, alkylated benzenes and their derivatives, alcohols such as methanol, ethanol, propanol, butanol and cyclohexanol, glycols, ketones such as cyclohexanone, gamma-butyrolactone, dimethyl fatty acid amides, fatty acids and fatty acid esters, and strongly polar solvent, for example amines such as N-methylpyrrolidone. In principle, it is also possible to use solvent mixtures, and mixtures of the abovementioned solvents and water. It is preferred to add the abovementioned solvents only after the method, when a dispersion of the active substance has formed.

In most cases, the aqueous dispersion according to the invention comprises no more than 30% by weight, preferably no more than 20% by weight, in particular no more than 10% by weight, of organic solvent.

In general, anionic, cationic and/or nonionic surfactants are added. Conventionally used anionic surfactants are, for example, ethoxylated mono-, di- and tri-alkylphenols (degree of ethoxylation of from 3 to 50, alkyl radical: C₄ to C₁₂) and ethoxylated fatty alcohols (degree of ethoxylation of from 3 to 80; alkyl radical: C₈ to C₃₆). Examples are the Lutensol® A brands (C₁₂ to C₁₄-fatty alcohol ethoxylates, degree of ethoxylation of from 3 to 8), Lutensol® AO brands (C₁₃ to C₁₅-oxoalcohol ethoxylates, degree of ethoxylation of from 3 to 30), Lutensol® AT brands (C₁₆ to C₁₈-fatty alcohol ethoxylates, degree of ethoxylation of from 11 to 80), Lutensol® ON brands (C₁₀-oxoalcohol ethoxylates, degree of ethoxylation of from 3 to 11) and the Lutensol® TO brands (C₁₃-oxoalcohol ethoxylates, degree of ethoxylation of from 3 to 20) from BASF SE. Others which are suitable are amphiphilic polymers, for example as described in EP 1 756 188 B1, paragraphs [0012] to [0068], or in DE 10 2006 001 529 A1, paragraphs [0025] to [0055], or based on the monomers acrylic acid, butyl methacrylate, methyl methacrylate, hydroxyethyl methacrylate and/or isobutyl methacrylate. Also suitable are amphiphilic block polymers, in particular based on ethylene oxide-propylene oxide. Examples are Pluronic® PE brands (EO-PO-EO tri-block polymers; EO: ethylene oxide, PO: propylene oxide). Others which are suitable are comb polymers, especially based on alkoxypolyoxyalkylene (meth)acrylates, such as comb polymers of methyl methacrylate, methacrylic acid and (methoxypolyethylene glycol) methacrylate (commercially available as Atlox® 4913 from Uniqema). Others which are conventionally used are polysaccharides and their derivatives, preferably polysaccharides based on inulin, for example Inutec® SP1 (inulin from chicory with grafted alkyl groups).

Examples of conventionally used anionic surfactants are alkali metal and ammonium salts of alkyl sulfates (alkyl radical: C8 to C12), for example sodium dodecyl sulfate, of sulfuric acid semiesters of ethoxylated alkanols (degree of ethoxylation of from 4 to 30, alkyl radical: C₁₂ to C₁₈) and ethoxylated alkylphenols (degree of ethoxylation of from 3 to 50, alkyl radical: C₄ to C₁₂), of alkylsulfonic acids (alkyl radical: C₁₂ to C₁₈) and of alkylaryl sulfonic acids (alkyl radical: C₉ to C₁₈). Furthermore, compounds of the general formula (I)

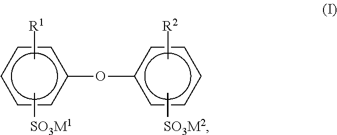

in which R¹ and R² are H atoms or C₄- to C₂₄-alkyl and are not simultaneously H atoms, and M¹ and M² can be alkali metal ions and/or ammonium ions, have further proved themselves as anionic surfactants. In the general formula (I), R¹ and R² are preferably linear or branched alkyl radicals having 6 to 18 C atoms, in particular having 6, 12 and 16 C atoms, or hydrogen, where R¹ and R² are not both simultaneously H atoms. M¹ and M² are preferably sodium, potassium or ammonium, with sodium being especially preferred. Especially advantageous are compounds (I) in which M¹ and M² are sodium, R¹ is a branched alkyl radical having 12 C atoms, and R² is an H atom or R¹. Frequently, one will use technical mixtures which comprise an amount of from 50 to 90% by weight of the monoalkylated product, such as, for example, Dowfax® 2A1 (brand of Dow Chemical Company). Others which are suitable are salts of dialkylsulfosuccinates, such as sodium dioctylsulfosuccinate (commercially available as Lutensit® A-BO from BASF SE). Furthermore suitable are arylphenol alkoxylates or their sulfated or phosphated derivatives, especially ethoxylated di- and tri-stryrylphenols or their sulfated or phosphated derivatives, such as Soprophor® from Rhodia (ammonium salt of the ethoxylated tristyrylphenol sulfate with approximately 16 ethylene oxide groups per molecule). Likewise suitable are partially neutralized alkali metal salts of (meth)acrylic acid/maleic acid copolymers, for example the Sokalan® brands of BASF, in particular Sokalan CP45 (acrylic acid/maleic acid copolymer, sodium salt, partially neutralized).

Suitable cationic surfactants are, as a rule, cationic salts which have one C₆- to C₁₈-alkyl, -alkylaryl or heterocyclic radical, for example primary, secondary, tertiary or quaternary ammonium salts, alkanol ammonium salts, pyridinium salts, imidazolinium salts, oxazolinium salts, morpholinium salts, thiazolinium salts, and salts of amine oxides, quinolinium salts, isoquinolinium salts, tropylium salts, sulfonium salts and phosphonium salts. Examples which may be mentioned are dodecylammonium acetate or the corresponding sulfate, the sulfates or acetates of the various 2-(N,N,N-trimethylammonium)ethyl paraffinic esters, N-cetylpyridinium sulfate, N-laurylpyridinium sulfate and N-cetyl-N,N,N-trimethylammonium sulfate N-dodecyl-N,N,N-trimethylammonium sulfate, N-octyl-N,N,N-trimethylammonium sulfate, N,N-distearyl-N,N-dimethylammonium sulfate and the Gemini surfactant N,N′-(lauryldimethyl)-ethylenediamine disulfate, ethoxylated tallow fatty alkyl N-methylammonium sulfate and ethoxylated oleylamine (for example Uniperol® AC from BASF SE, approximately 12 ethylene oxide units). What is essential is that the nucleophilicity of the anionic counter groups is as low as possible, such as, for example, perchlorate, sulfate, phosphate, nitrate and carboxylates such as acetate, trifluoroacetate, trichloroacetate, propionate, oxalate, citrate, benzoate, and conjugated anions of organosulfonic acids such as, for example, methylsulfonate, trifluoromethylsulfonate and para-toluenesulfonate, furthermore tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

The concentration of surfactant added or its mixture can vary within wide ranges. Usually, concentrations of from 0.1 to 30% by weight, based on the aqueous dispersion, are used.

Examples of anionic emulsifiers are metal salts, such as salts, oxides and hydroxides of calcium, magnesium, iron, zinc, nickel, titanium, aluminum, silicon, barium or manganese. The following should be mentioned: magnesium hydroxide, magnesium carbonate, magnesium oxide, calcium oxalate, calcium carbonate, barium carbonate, barium sulfate, titanium dioxide, alumina, aluminum hydroxide and zinc sulfide. Silicates, bentonite, hydroxyapatite and hydrotalcites may also be mentioned.

Examples of thickeners (compounds which impart a pseudoplastic rheology to the formulation, i.e. high viscosity at rest and low viscosity in the moved state) are, for example, polysaccharides such as xanthan gum, or organic sheet minerals.

Suitable antifoam agents are, for example, silicone emulsions, long-chain alcohols, fatty acids, organofluorine compounds and their mixtures.

Bactericides may be added to stabilize the aqueous formulation. Bactericides which may be present in the formulations according to the invention and which are suitable are all those bactericides conventionally used for the formulation of agrochemical active substances, such as, for example, dichlorophen and benzyl alcohol hemiformal.

Examples of suitable antifreeze agents are polyhydric alcohols such as ethylene glycol, propylene glycol or glycerol, preferably glycerol. From 0 to 30% by weight, preferably from 10 to 20% by weight, based on the aqueous solution, are generally added.

Adhesives which may be present in seed-dressing formulations and which are suitable are all binders which can conventionally be employed in seed-dressing products. The following may preferably be mentioned: polyvinylpyrrolidone, polyvinyl acetate, polyvinyl alcohol and tylose.

Moreover, colorants may also optionally be added to the formulations according to the invention. In this context, colorants which are suitable are all those conventionally used for such purposes, for example C.I. Pigment Red 48:2. In this context, both pigments, which are sparingly soluble in water, and dyes, which are soluble in water, can be used.

In general, it is not necessary to add crystallization inhibitors. It is preferred to add no more than 5% by weight, especially preferably no more than 1% by weight and specifically no crystallization inhibitors.

The present invention furthermore relates to a solid composition comprising active substance particles with a particle size of up to 10 μm and an amphiphile, obtained by drying the dispersion according to the invention. The drying can be effected for example by spray-drying. Frequently, the water content of the solid composition is no more than 10% by weight, preferably no more than 3% by weight, in particular 0.5% by weight.

The invention furthermore relates to the use of an amphiphile, for example an aliphatic acid or a salt thereof, the aliphatic acid being soluble in water at 20° C. to no more than 10% by weight, for slowing down the growth of active substance particles with a particle size of up to 10 μm in aqueous dispersion. Slowing down particle growth is understood as meaning that, after storage of the dispersion for 24 h at 20° C., the particle size has increased less than in a comparative solution without amphiphile.

The dispersion according to the invention, or the solid composition according to the invention can be used for controlling phytopathogenic fungi and/or undesired vegetation and/or undesired attack by insects or mites and/or for regulating the growth of plants, by allowing the dispersion or the solid composition to act on the respective pests, their environment and/or the plants to be protected from the respective pest, on the soil and/or on undesired plants and/or on the useful plants and/or their environment.

The dispersion according to the invention, or the solid composition according to the invention can be used for controlling undesired attack by insects or mites on plants and/or for controlling phytopathogenic fungi and/or for controlling undesired vegetation by treating seed of useful plants with the dispersion or the solid composition.

The invention furthermore relates to seed, treated with the dispersion according to the invention or the solid composition according to the invention. The expression “treated” generally means dressed. By dressing the seed, the dispersion according to the invention will generally remain on the seed. Preferably, the seed comprises the dispersion according to the invention or the solid composition according to the invention.

The advantage of the present invention is that the aqueous dispersion of active substance particles with a particle size of below 10 μm shows slowed-down particle growth (Ostwald ripening). A further advantage is that the particles settle more slowly and crystallize more slowly, or not at all. It is also advantageous that this stabilization of the dispersion was achieved with the aid of an environmentally-friendly agent, which is, for example, a fatty acid. The method according to the invention has the advantage that it can be carried out with existing installations. Furthermore, stable aqueous dispersions of active substance particles can be obtained.

The examples which follow illustrate the invention without imposing any limitation.

### EXAMPLES

First, 16 g of pyraclostrobin and 0/1/2/4 g (0/6/11/25% by weight based on pyraclostrobin) of erucic acid were suspended in 144 g of propylene glycol for one hour, using 3 mm glass beads and a shaker (Red Devil). The resulting, still coarsely-particulate suspension was conveyed through a mixing nozzle of a dissolving cell at a flow rate of 1 kg/h. Propylene glycol was conveyed thereto at a temperature of 200° C. and a pumping rate of 2 kg/h. The two streams were mixed turbulently in the dissolving cell, and a solution of pyraclostrobin and erucic acid was generated.

The solution thus obtained was conveyed to a second mixing nozzle and mixed turbulently with water (precooled to 5° C.) at a pumping rate of 16 kg/h. A particle formation of pyraclostrobin takes place during the mixing. The amorphous pyraclostrobin precipitate thus obtained was discharged and analyzed. The aqueous suspension comprised 0.42% by weight of pyraclostrobin and 0/0.025/0.05/0.11% by weight of erucic acid.

The particle sizes of pyraclostrobin were determined over 24 h by means of laser diffraction (Malvern Mastersizer S) and laser scattering (Brookhaven Instruments BI90) (tables 1 and 2).

For comparison purposes, the experiment was repeated, with erucic acid being replaced by 4 g of sodium dodecylsulfate (SDS). The aqueous suspension thus obtained comprised 0.42% by weight of pyraclostrobin and 0.1% by weight of SDS.

The experiment showed that the formulations with erucic acid show slowed-down particle growth in comparison with the mixture without erucic acid.

TABLE 1
Analysis of the particle size of pyraclostrobin
(proportion < 1 μm in %) by laser diffraction

| | Erucic acid | Erucic acid | Erucic acid | Erucic acid | SDS |
|---|---|---|---|---|---|
| Time [h] | 0 g | 4 g | 2 g | 1 g | 4 g |
| 0 | 100 | 100 | 100 | 100 | 100 |
| 1 | 97.6 | 100 | 100 | 100 | 100 |
| 2 | 92.2 | 100 | 98.4 | 98.2 | 98.2 |
| 3 | 81 | 100 | — | 97.7 | 94.2 |
| 4 | 74.6 | 100 | 97.6 | 97.7 | 87 |
| 5 | 69.1 | 96.8 | 95.7 | 98.3 | 87 |
| 6 | 64.9 | 98.5 | 97.5 | 96.1 | 77 |
| 7 | — | 98.7 | 94.4 | 98.2 | — |
| 8 | — | — | — | 95.1 | — |
| 24 | 50 | 91 | 70 | 77.1 | 30 |

TABLE 2
Analysis of the particle size (D in nm) of
pyraclostrobin by means of laser scattering

| | Erucic acid | Erucic acid | Erucic acid | Erucic acid | SDS |
|---|---|---|---|---|---|
| Time [h] | 0 g | 4 g | 2 g | 1 g | 4 g |
| 0 | 291 | 247 | 268 | 250 | 256 |
| 1 | 584 | 273 | 502 | 312 | 500 |
| 2 | 685 | 279 | 543 | 363 | 580 |
| 3 | 787 | 285 | 553 | 378 | 670 |
| 4 | 845 | 298 | 583 | 413 | 680 |
| 5 | 850 | 309 | 601 | 490 | 730 |
| 6 | 889 | 335 | 629 | 508 | 807 |
| 7 | — | 337 | 648 | 525 | — |
| 8 | — | — | 670 | 535 | — |
| 24 | 1132 | 405 | 702 | 702 | 943 |

1-14. (canceled)

15. An aqueous dispersion comprising solid active substance particles with a particle size of up to 10 μm and an amphiphile, wherein the amphiphile is an aliphatic acid or a salt thereof, and wherein the aliphatic acid is a fatty acid having at least 20 carbon atoms and is soluble in water at 20° C. to no more than 10% by weight.

16. The dispersion according to claim 15, wherein the aliphatic acid is a fatty acid having from 22 to 36 carbon atoms.

17. The dispersion according to claim 15, wherein the solid active substance particles are soluble in water to no more than 10 g/l at 20° C.

18. The dispersion according to claim 15, wherein the solid active substance particles are a pesticide.

19. The dispersion according to claim 15, wherein no more than 40% by weight of the amphiphile is present, based on the active substance.

20. The dispersion according to claim 15, wherein from 1 to 60% by weight of active substance particles are present.

21. The dispersion according to claim 15, wherein the active substance particles consist of an active substance.

22. A method of preparing a dispersion according to claim 15 by contacting the active substance with the amphiphile.

23. The method according to claim 22, wherein the active substance is a pesticide which is insoluble in water.

24. A solid composition comprising active substance particles with a particle size of up to 10 μm and an amphiphile, obtained by drying the aqueous dispersion according to claim 15.

25. A method for slowing down the growth of active substance particles with a particle size of up to 10 μm in an aqueous dispersion comprising applying an amphiphile according to claim 15 to the aqueous dispersion.

26. A method for controlling phytopathogenic fungi and/or undesired vegetation and/or undesired attack by insects or mites and/or for regulating the growth of plants, comprising treating the respective pests, their environment and/or the plants to be protected from the respective pest, on the soil and/or on undesired plants and/or on the useful plants and/or their environment with the dispersion according to claim 15.

27. A method for controlling phytopathogenic fungi and/or undesired vegetation and/or undesired attack by insects or mites and/or for regulating the growth of plants, comprising treating the respective pests, their environment and/or the plants to be protected from the respective pest, on the soil and/or on undesired plants and/or on the useful plants and/or their environment with the solid composition according to claim 24.

28. A method for controlling undesired attack by insects or mites on plants and/or for controlling phytopathogenic fungi and/or for controlling undesired vegetation comprising treating seed of useful plants with the dispersion according to claim 15.

29. A method for controlling undesired attack by insects or mites on plants and/or for controlling phytopathogenic fungi and/or for controlling undesired vegetation comprising treating seed of useful plants with the solid composition according to claim 24.

30. A seed treated with the dispersion according to claim 15.

31. A seed treated with the solid composition according to claim 24.
